(19) United States
(12) Patent Application Publication
(10) Pub. No.: US 2014/0047194 A1
(43) Pub. Date: Feb. 13, 2014

(54) PROCESSOR AND CONTROL METHOD THEREOF

(71) Applicant: FUJITSU LIMITED, Kawasaki-shi (JP)

(72) Inventor: MASANORI DOI, Kawasaki (JP)

(21) Appl. No.: 13/911,080

(22) Filed: Jun. 6, 2013

(30) Foreign Application Priority Data
Aug. 9, 2012 (JP) 2012-177366

(51) Int. Cl. G06F 12/08

(52) U.S. Cl. CPC G06F 12/0808
USPC 711/144

(57) ABSTRACT

A processor has a first core unit which outputs history information and occupancy mode information related to an arithmetic processing, a memory which has a first storage area and a second storage area, and a control circuit which writes the history information outputted by the first core unit into the first storage area of the memory when the occupancy mode information outputted by the first core unit indicates invalidity, and writes the history information outputted by the first core unit into the first storage area and the second storage area of the memory when the occupancy mode information outputted by the first core unit indicates validity.

### CROSS-REFERENCE TO RELATED APPLICATION

This application is based upon and claims the benefit of priority of the prior Japanese Patent Application No. 2012-177366, filed on Aug. 9, 2012, the entire contents of which are incorporated herein by reference.

### FIELD

The embodiment discussed herein is directed to a processor and a control method of the processor.

### BACKGROUND

There is known a multiprocessor of a plurality of processors including a main processor which are mutually combined via a common bus (for example, see Patent Document 1). The multiprocessor monitors trace information stored by each processor for a fault analysis, debugging or the like.

Further, there is known a history recording device which records history related to an operation inside a computer (for example, see Patent Document 2). The history recording device records internal information and valid external information while clarifying a time relation between internal information of the computer and input information from the outside.

[Patent Document 1] Japanese Laid-open Patent Publication No. 63-147243

[Patent Document 2] Japanese Laid-open Patent Publication No. 5-40671

### SUMMARY

A processor has a first core unit which outputs history information and occupancy mode information related to an arithmetic processing, a memory which has a first storage area and a second storage area, and a control circuit which writes the history information outputted by the first core unit into the first storage area of the memory when the occupancy mode information outputted by the first core unit indicates invalidity, and writes the history information outputted by the first core unit into the first storage area and the second storage area of the memory when the occupancy mode information outputted by the first core unit indicates validity.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a processor according to an embodiment;

FIG. 2 is a diagram illustrating a configuration example of a first core unit, a second core unit, a history selection circuit and a history unit;

FIG. 3 is a diagram illustrating a configuration example of the history unit of FIG. 2;

FIG. 4 is a diagram for explaining an operation example of a first address circuit and a second address circuit of FIG. 3; and

FIG. 5 is a diagram illustrating a configuration example of a selection circuit of FIG. 3.

### DESCRIPTION OF EMBODIMENT

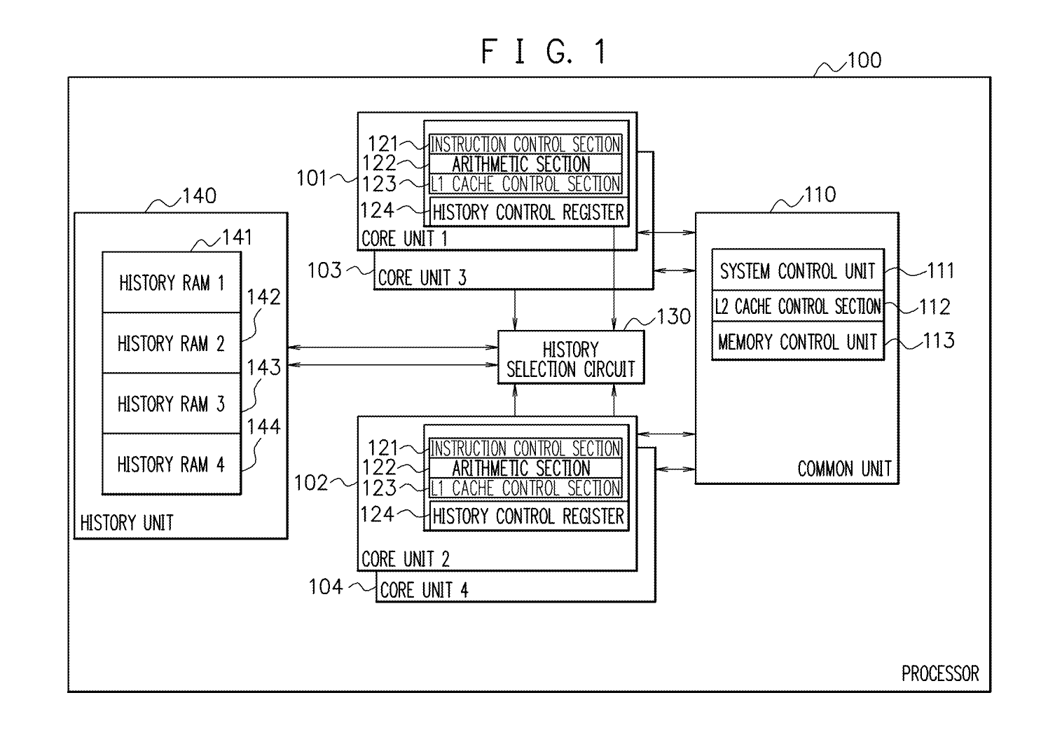

FIG. 1 is a diagram illustrating a configuration example of a processor 100 according to an embodiment. The processor 100, for example, has a first core unit 101, a second core unit 102, a third core unit 103, a fourth core unit 104, a common unit 110, a history selection circuit 130 and a history unit 140. Each of the four core units 101 to 104 has an instruction control section 121, an arithmetic section 122, a primary (level 1) cache control section 123 and a history control register 124. The common unit 110 has a system control unit 111, a secondary (level 2) cache control section 112 and a memory control unit 113, and performs common control to the four core units 101 to 104. The system control unit 111 analyzes an access or a program from a service processor connected to the outside and accesses the history control register 124 in each of the core units 101 to 104.

The history unit 140 has a memory including a first history RAM (random access memory) 141, a second history RAM 142, a third history RAM 143 and a fourth history RAM 144. The first history RAM 141 is a first storage area, the second history RAM 142 is a second storage area, the third history RAM 143 is a third storage area and the fourth history RAM 144 is a fourth storage area.

Each of the four core units 101 to 104 outputs history information and occupancy mode information related to an arithmetic processing by execution of the program to the history selection circuit 130. The history information is history information related to the arithmetic processing of the core units 101 to 104 per a cycle or per an event, and includes, for example, a program counter value which indicates an execution address of the present program, a sequence of executed instructions, a content of a pipeline processing, and/or a value of address conversion.

When the occupancy mode information outputted from the four core units 101 to 104 all indicate invalidity, the history selection circuit 130 writes the history information inputted from the first core unit 101 into the first history RAM 141, writes the history information inputted from the second core unit 102 into the second history RAM 142, writes the history information inputted from the third core unit 103 into the third history RAM 143, and writes the history information inputted from the fourth core unit 104 into the fourth history RAM 144.

The history information written into the history RAMs 141 to 144 is information helpful to an error analysis or the like of the arithmetic processing of the processor 100. When the error analysis is done, it is necessary to trace back from a program counter value where an error is detected to a program counter value of a cause of the error, to investigate an operating status of the processor 100 during that time and to analyze the problem.

Since a program to be executed by the processor 100 is growing complex in recent years, an analysis of an error becomes difficult, so that high-capacity history RAMs 141 to 144 are necessary.

The processor 100 is a multiprocessor which has the plurality of core units 101 to 104 that operate at high frequencies. It is difficult to drastically enlarge a semiconductor chip size of the processor 100 for the purpose of mounting the plural core units 101 to 104 in the processor 100, when raising of a productivity is aimed at. Since it is necessary to make areas of the plural core units 101 to 104 as small as possible, an increase of capacities of the history RAMs 141 to 144 is difficult. It is necessary not to enlarge the areas of the core units 101 to 104 and to secure the high-capacity history RAMs 141 to 144.

In the present embodiment, by providing the history RAMs 141 to 144 outside the core units 101 to 104 and changing a region which one of the core units 101 to 104 can use of the history RAMs 141 to 144 in correspondence with the occupancy mode information outputted by the core units 101 to 104, a high-capacity history RAM is realized. The occupancy mode information is information to occupy the history RAMs 141 to 144, and is validated when a long-term operation history or a detailed operation history becomes necessary in an error analysis or a program analysis of a certain core unit.

When the error analysis using the history information becomes necessary, an external service processor or program selects the core unit which requires the error analysis. The system control unit 111 validates the occupancy mode information of the history control register 124 in the selected core unit. Thereby, the selected core unit outputs occupancy mode information of validity.

For example, when the first core unit 101 outputs occupancy mode information of validity and the second to fourth core units 102 to 104 output occupancy mode information of invalidity, the history information outputted by the first core unit 101 is written into the history RAMs 141 to 144.

Further, when the second core unit 102 outputs occupancy mode information of validity and the first, third and fourth core units 101, 103, 104 output occupancy mode information of invalidity, the history information outputted by the second core unit 102 is written into the history RAMs 141 to 144.

Further, when the third core unit 103 outputs occupancy mode information of validity and the first, second and fourth core units 101, 102 and 104 output occupancy mode information of invalidity, the history information outputted by the third core unit 103 is written into the history RAMs 141 to 144.

Further, when the fourth core unit 104 outputs occupancy mode information of validity and the first to third core units 101 to 103 output occupancy mode information of invalidity, the history information outputted by the fourth core unit 104 is written into the history RAMs 141 to 144.

Further, it is also possible to divide the region into a region of the history RAMs 141 and 142 and a region of the history RAMs 143 and 144. For example, when the first core unit 101 outputs occupancy mode information of validity and the second core unit 102 outputs occupancy mode information of invalidity, the history information outputted by the first core unit 101 is written into the history RAMs 141 and 142. Further, when the third core unit 103 outputs occupancy mode information of validity and the fourth core unit 104 outputs occupancy mode information of invalidity, the history information outputted by the third core unit 103 is written into the history RAMs 143 and 144.

As described above, as a result that the core units 101 to 104 each validate the occupancy mode information, the region into which the history information is written can be made broad, so that a long-term operation history or detailed operation history can be written and a complex error analysis and program analysis become possible.

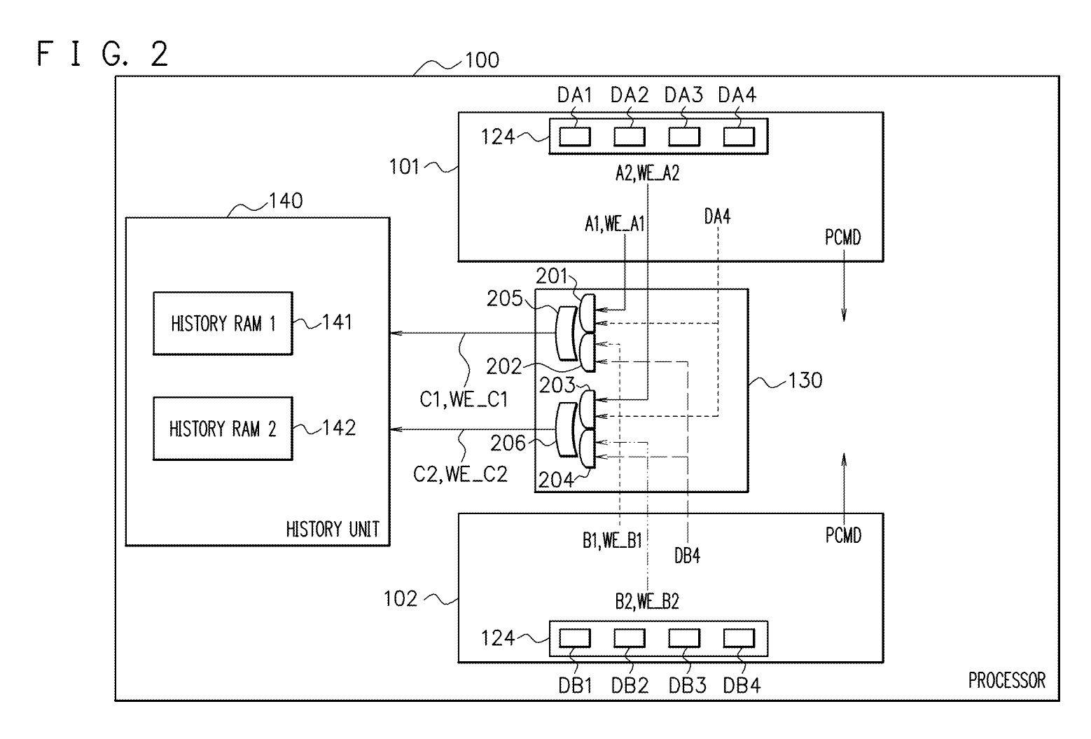

FIG. 2 is a diagram illustrating a configuration example of a first core unit 101, a second core unit 102, a history selection circuit 130 and a history unit 140. Hereinafter, an example in which a processor 100 has the two core units 101 and 102 will be described, but the same applies to a case where the processor 100 has three or more core units. The history unit 140 has a first history RAM 141 and a second history RAM 142.

A history control register 124 of the first core unit 101 has information DA1 to DA4. The validity information DA1 is information of validity or invalidity of a history function. The control information DA2 is information indicating whether a timing to obtain history information is per a clock or per an event. The event information DA3 is information for designating a program counter value, a content of a pipeline, a content of a specific processing block or the like as a content of the history information. With regard to the occupancy mode information DA4, as described above, when the occupancy mode information DA4 is validated (value “1”) a region into which the history information is written becomes broad, and when the occupancy mode information DA4 is invalidated (value “0”), the region into which the history information is written becomes narrow.

The first core unit 101 obtains history information in correspondence with the information DA1 to DA4 in the history control register 124. The first core unit 101 outputs first history information A1 and a first write enable signal WE_A1 of validity in correspondence with the event information DA3, when the occupancy mode information DA4 is of invalidity. Further, the first core unit 101 outputs the first history information A1 and the first write enable signal WE_A1 of validity as well as second history information A2 and a second write enable signal WE_A2 of validity in correspondence with the event information DA3, when the occupancy mode information DA4 is of validity.

Further, the first core unit 101 validates (value “1”) sharing mode information PCMD when the occupancy mode information DA4 is of validity and the event information DA3 indicates a program counter value, and invalidates (value “0”) the sharing mode information PCMD in other cases.

A history control register 124 of the second core unit 102 has information DB1 to DB4. The information DB1 to DB4 is similar to information DA1 to DA4 of the first core unit 101.

The second core unit 102 obtains the history information in correspondence with the information DB1 to DB4 in the history control register 124. The second core unit 102 outputs first history information B1 and a first write enable signal WE_B1 of validity in correspondence with the event information DB3, when the occupancy mode information DB4 is of invalidity. Further, the second core unit 102 outputs the first history information B1 and the first write enable signal WE_B1 of validity as well as second history information B2 and a second write enable signal WE_B2 of validity in correspondence with the event information DB3, when the occupancy mode information DB4 is of validity.

Further, the second core unit 102 validates (value 1”) sharing mode information PCMD when the occupancy mode information DB4 is of validity and the event information DB3 indicates a program counter value, and invalidates (value “0”) the sharing mode information PCMD in other cases.

A history selection circuit 130 has logical product (AND) circuits 201 to 204 and logical sum (OR) circuits 205, 206. The logical product circuit 201 outputs the first history information A1 and the first write enable signal WE_A1 when the occupancy mode information DA4 is of validity (value “1), and outputs “0” when the occupancy mode information DA4 is of invalidity (value “0”). The logical product circuit 202 outputs the first history information B1 and the first write enable signal WE_B1 when the occupancy mode information DB4 is of validity (value “1”), and outputs “0” when the occupancy mode information DB4 is of invalidity (value “0”). The logical product circuit 203 outputs the second history information A2 and the second write enable signal WE_A2 when the occupancy mode information DA4 is of validity (value “1”), and outputs “0” when the occupancy mode information DA4 is of invalidity (value “0”). The logical product circuit 204 outputs the second history information B2 and the second write enable signal WE_B2 when the occupancy mode information DB4 is of validity (value “1”), and outputs “0” when the occupancy mode information DB4 is of invalidity (value “0”). The logical sum circuit 205 outputs a logical sum signal of the logical product circuits 201 and 202 to the history unit 140 as first history information C1 and a first write enable signal WE_C1. The logical sum circuit 206 outputs a logical sum signal of the logical product circuits 203 and 204 to the history unit 140 as second history information C2 and a second write enable signal WE_C2.

As described above, when the occupancy mode information DA4 is of validity (value “1”) and the occupancy mode information DB4 is of invalidity (value “0”), the first history information C1 is the first history information A1, the first write enable signal WE_C1 is the first write enable signal WE_A1, the second history information C2 is the second history information A2, and the second write enable signal WE_C2 is the second write enable signal WE_A2.

Further, when the occupancy mode information DA4 is of invalidity (value “0”) and the occupancy mode information DB4 is of validity (value “1”), the first history information C1 is the first history information B1, the first write enable signal WE_C1 is the first write enable signal WE_B1, the second history information C2 is the second history information B2, and the second write enable signal WE_C2 is the second write enable signal WE_B2.

Next, an operation of the history selection circuit 130 in a case where the occupancy mode information DA4 is of invalidity (value “0”) and the occupancy mode information DB4 is of invalidity (value “0”) will be described. In such a case, the first history information C1 is the first history information A1, the first write enable signal WE_C1 is the first write enable signal WE_A1, the second history information C2 is the first history information B1, and the second write enable signal WE_C2 is the first write enable signal WE_B1.

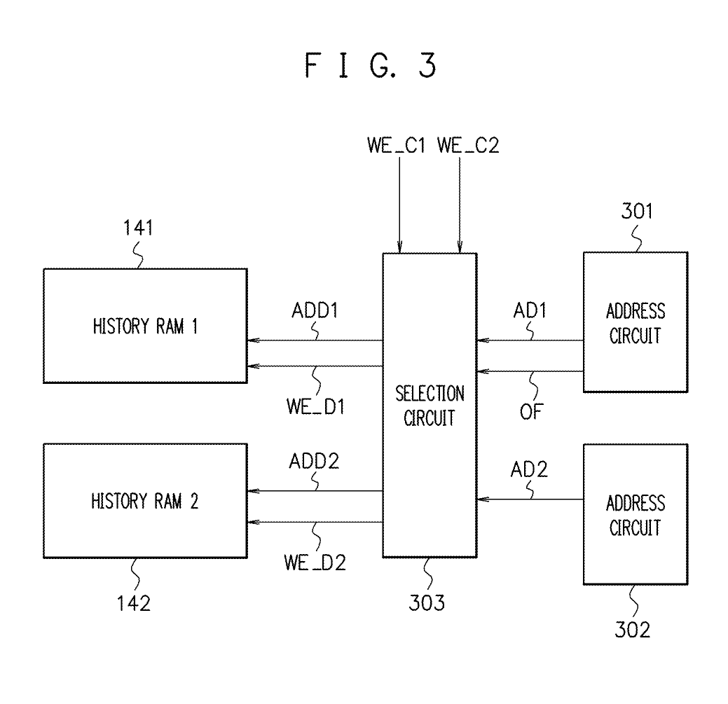

FIG. 3 is a diagram illustrating a configuration example of the history unit 140 of FIG. 2. The history unit 140 has the first history RAM 141, the second history RAM 142, a selection circuit 303, a first address circuit 301 and a second address circuit 302. The first address circuit 301 outputs a first address AD1 and an overflow bit OF to the selection circuit 303. The second address circuit 302 outputs a second address AD2 to the selection circuit 303. The selection circuit 303 inputs the first address AD1, the overflow bit OF, the second address AD2, the first write enable signal WE_C1 and the second write enable signal WE_C2, and outputs a first address ADD1 and a first write enable signal WE_D1 to the first history RAM 141, and outputs a second address ADD2 and a second write enable signal WE_D2 to the second history RAM 142.

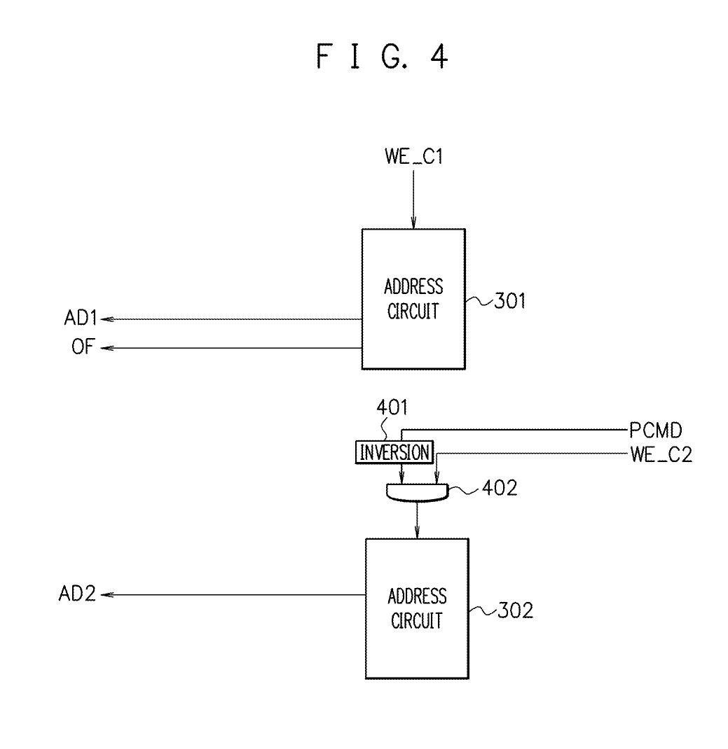

FIG. 4 is a diagram for explaining an operation example of the first address circuit 301 and the second address circuit 302 of FIG. 3. The first address circuit 301 increments the first address AD1 (for example, 10-bit) whose initial value is “0”, when the first write enable signal WE_C1 is of validity. Further, the first address circuit 301 makes the overflow bit OF “1” when the first address AD1 overflows. When the first address AD1 does not overflow, the overflow bit OF is “0”.

An inversion circuit 401 logically inverses sharing mode information PCMD and outputs to the logical product circuit 402. The logical product circuit 402 outputs the second write enable signal WE_C2 to the second address circuit 302 when the sharing mode information PCMD is of invalidity (value “0”), and outputs a write enable signal of invalidity to the second address circuit 302 in other cases. The second address circuit 302 increments the second address AD2 when a write enable signal outputted by the logical product circuit 402 is of validity.

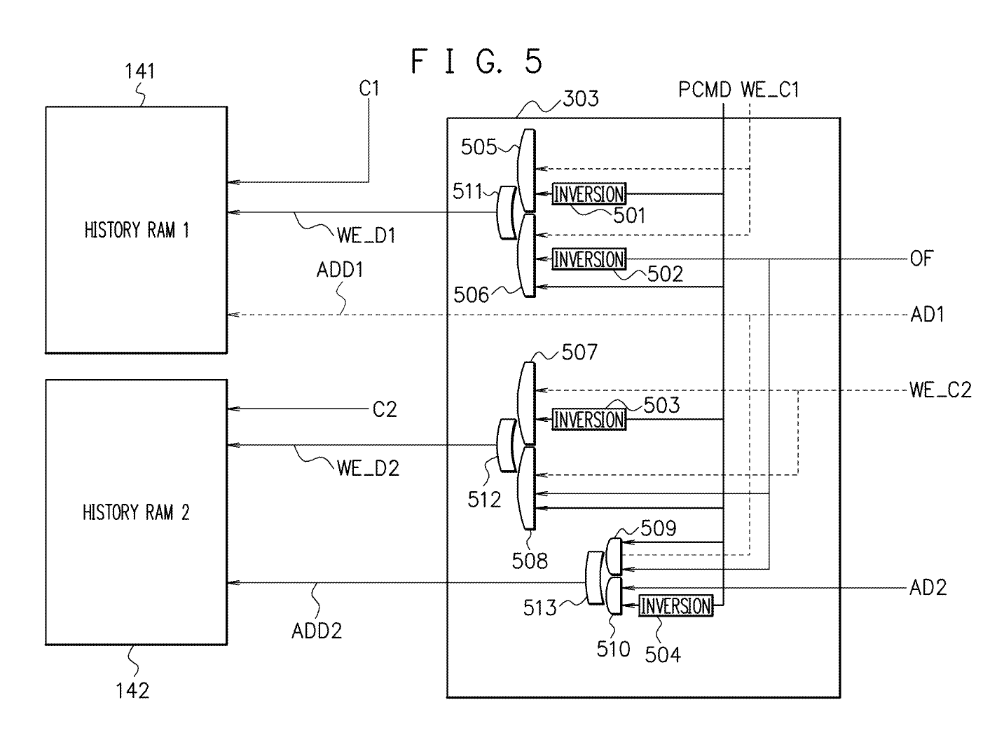

FIG. 5 is a diagram illustrating a configuration example of the selection circuit 303 of FIG. 3. The selection circuit 303 has inversion circuits 501 to 504, logical product circuits 505 to 510 and logical sum circuits 511 to 513. The inversion circuit 501 logically inverses sharing mode information PCMD and outputs to the logical product circuit 505. The inversion circuit 502 logically inverses an overflow bit OF and outputs to the logical product circuit 506. The inversion circuit 503 logically inverses the sharing mode information PCMD and outputs to the logical product circuit 507. The inversion circuit 504 logically inverses the sharing mode information PCMD and outputs to the logical product circuit 510.

The logical product circuit 505 outputs the first write enable signal WE_C1 when the sharing mode information PCMD is of invalidity (value “0”), and outputs “0” when the sharing mode information PCMD is of validity (value “1”). The logical product circuit 506 outputs the first write enable signal WE_C1 when the overflow bit OF is “0” and the sharing mode information PCMD is of validity (value “1”), and outputs “0” in other cases. The logical sum circuit 511 outputs a logical sum signal of output signals of the logical product circuits 505 and 506 to the first history RAM 141 as the first write enable signal WE_D1. The first history RAM 141 inputs, in addition to the first write enable signal WE_D1, the first address AD1 as a first address ADD1. The first history RAM 141 writes the first history information C1 into the first address ADD1 when the first write enable signal WE_D1 is of validity.

As described above, when the sharing mode information PCMD is of invalidity (value “0”), the first write enable signal WE_C1 is outputted as the first write enable signal WE_D1. Further, also when the overflow bit OF is “0” and the sharing mode information PCMD is of validity (value “1”), the first enable signal WE_C1 is outputted as the first write enable signal WE_D1.

The logical product circuit 507 outputs the second write enable signal WE_C2 when the sharing mode information PCMD is of invalidity (value “0”), and outputs “0” when the sharing mode information PCMD is of validity (value “1”). The logical product circuit 508 outputs the second write enable signal WE_C2 when the overflow bit OF is “1” and the sharing mode information PCMD is of validity (value “1”), and outputs “0” in other cases. The logical sum circuit 512 outputs a logical sum signal of output signals of the logical product circuits 507 and 508 to the second history RAM 142 as the second write enable signal WE_D2.

As described above, when the sharing mode information PCMD is of invalidity (value “0”), the second write enable signal WE_C2 is outputted as the second write enable signal WE_D2. Further, also when the overflow bit OF is “1” and the sharing mode information PCMD is of validity (value “1”), the second write enable signal WE_C2 is outputted as the second write enable signal WE_D2.

The logical product circuit 509 outputs the first address AD1 when the sharing mode information PCMD is of validity (value “1”) and the overflow bit OF is “1”, and outputs “0” in other cases. The logical product circuit 510 outputs the second address AD2 when the sharing mode information PCMD is of invalidity (value “0”), and outputs “0” when the sharing mode information PCMD is of validity (value “1”). The logical sum circuit 513 outputs a logical sum signal of output signals of the logical product circuits 509 and 510 to the second history RAM 142 as the second address ADD2.

As described above, when the sharing mode information PCMD is of validity (value “1”) and the overflow bit OF is “1”, the first address AD1 is outputted as the second address ADD2. Further, when the sharing mode information PCMD is of invalidity (value “0”), the second address AD2 is outputted as the second address ADD2.

The second history RAM 142 writes the second history information C2 into the second address ADD2 when the second write enable signal WE_D2 is of validity.

First explained will be an operation at a time that the occupancy mode information DA4 outputted by the first core unit 101 indicates invalidity, the occupancy mode information DB4 outputted by the second core unit 102 indicating invalidity. In such a case, the first history information A1 outputted by the first core unit 101 is the first history information C1, the first write enable signal WE_A1 outputted by the first core unit 101 is the first write enable signal WE_D1, and the first address AD1 generated by the first address circuit 301 is the first address ADD1. Further, the first history information B1 outputted by the second core unit 102 is the second history information C2, the first write enable signal WE_B1 outputted by the second core unit 102 is the second write enable signal WE_D2, and the second address AD2 generated by the second address circuit 302 is the second address ADD2. As a result, the first history information A1 of the first core unit 101 is written into the first history RAM 141, and the first history information B1 of the second core unit 102 is written into the second history RAM 142.

Further explained will be an operation at a time that the occupancy mode information DA4 outputted by the first core unit 101 indicates validity, the sharing mode information PCMD outputted by the first core unit 101 indicating invalidity, and the sharing mode information DB4 outputted by the second core unit 102 indicating invalidity. In such a case, the first history information A1 outputted by the first core unit 101 is the first history information C1, the first write enable signal WE_A1 outputted by the first core unit 101 is the first write enable signal WE_D1, and the first address AD1 generated by the first address circuit 301 is the first address ADD1. Further, the second history information A2 outputted by the first core unit 101 is the second history information C2, the second write enable signal WE_A2 outputted by the first core unit 101 is the second write enable signal WE_D2, and the second address AD2 generated by the second address circuit 302 is the second address ADD2. As a result, the first history information A1 of the first core unit 101 is written into the first history RAM 141 and the second history information A2 of the first core unit 101 is written into the second history RAM 142.

Further explained will be an operation at a time that the occupancy mode information DB4 outputted by the second core unit 102 indicates validity, the sharing mode information PCMD outputted by the second core unit 102 indicating invalidity, and the occupancy mode information DA4 outputted by the first core unit 101 indicating invalidity. In such a case, the first history information B1 outputted by the second core unit 102 is the first history information C1, the first write enable signal WE_B1 outputted by the second core unit 102 is the first write enable signal WE_D1, and the first address AD1 generated by the first address circuit 301 is the first address ADD1. Further, the second history information B2 outputted by the second core unit 102 is the second history information C2, the second write enable signal WE_B2 outputted by the second core unit 102 is the second write enable signal WE_D2, and the second address AD2 generated by the second address circuit 302 is the second address ADD2. As a result, the first history information B1 of the second core unit 102 is written into the first history RAM 141 and the second history information B2 of the second core unit 102 is written into the second history RAM 142.

Further explained will be an operation at a time that the occupancy mode information DA4 outputted by the first core unit 101 indicates validity, the sharing mode information PCMD outputted by the first core unit 101 indicating validity, and the occupancy mode information DB4 outputted by the second core unit 102 indicating invalidity. In such a case, the first history information A1 outputted by the first core unit 101 is the first history information C1 and the second history information A2 outputted by the first core unit 101 is the second history information C2. Then, with both the first history RAM 141 and the second history RAM 142 being one address space, the first history information A1 and the second history information A2 outputted by the first core unit 101 are written into the first history RAM 141 and the second history RAM 142. Since the overflow bit OF is “0” at first, the first address AD1 is inputted to the first history RAM 141 as the first address ADD1. The first history information A1 and the second history information A2 are written into the first address ADD1 of the first history RAM 141. By increment of the first address ADD1, the first history information A1 and the second history information A2 are sequentially written starting from the address ADD1 of “0” of the first history RAM 141. When the first address ADD1 exceeds the last address of the first history RAM 141, the overflow bit OF becomes “1” and the first address AD1 of “0” is inputted to the second history RAM 142 as the second address ADD2. The first history information A1 and the second history information A2 are written into the second address ADD2 of the second history RAM 142. By increment of the second address ADD2, the first history information A1 and the second history information A2 are sequentially written starting from the address ADD2 of “0” of the second history RAM 142. As described above, the first history information A1 and the second history information A2 are written into the first history RAM 141 at first, and when the first history RAM 141 becomes full, subsequently written into the second history RAM 142. In other words, the first history RAM 141 and the second history RAM 142 are used as one address space, into which the first history information A1 and the second history information A2 are written.

Next explained will be an operation at a time that the occupancy mode information DB4 outputted by the second core unit 102 indicates validity, the sharing mode information PCMD outputted by the second core unit 102 indicating validity, and the occupancy mode information DA4 outputted by the first core unit 101 indicating invalidity. In such a case, the first history information B1 outputted by the second core unit 102 is the first history information C1, and the second history information B2 outputted by the second core unit 102 is the second history information C2. Then, with both the first history RAM 141 and the second history RAM 142 being one address space, the first history information B1 and the second history information B2 outputted by the second core unit 102 are written into the first history RAM 141 and the second history RAM 142. Since the overflow bit OF is “0” at first, the first address AD1 is inputted to the first history RAM 141 as the first address ADD1. The first history information B1 and the second history information B2 are written into the first address ADD1 of the first history RAM 141. By increment of the first address ADD1, the first history information B1 and the second history information B2 are sequentially written starting from the address ADD1 of “0” of the first history RAM 141. When the first address ADD1 exceeds the last address of the first history RAM 141, the overflow bit OF becomes “1”, and the first address AD1 of “0” is inputted to the second history RAM 142 as the second address ADD2. The first history information B1 and the second history information B2 are written into the second address ADD2 of the second history RAM 142. By increment of the second address ADD2, the first history information B1 and the second history information B2 are sequentially written starting from the address ADD2 of “0” of the second history RAM 142. As described above, the first history information B1 and the second history information B2 are written into the first history RAM 141 at first, and when the first history RAM 141 becomes full, subsequently written into the second history RAM 142. In other words, the first history RAM 141 and the second history RAM 142 are used as one address space, into which the first history information B1 and the second history information B2 are written.

As described above, the common unit 110 and the history selection circuit 130 of FIG. 1, the first address circuit 301, the second address circuit 302 and the selection circuit 303 of FIG. 3, and the inversion circuit 401 and the logical product circuit 402 of FIG. 4 are control circuits which write history information into the history RAMs 141 to 144. Hereinafter, a control method of the control circuit will be described.

When the occupancy mode information DA4 outputted by the first core unit 101 indicates invalidity, the history information A1 outputted by the first core unit 101 is written into the first history RAM 141, and when the occupancy mode information DA4 outputted by the first core unit 101 indicates validity, the first history information A1 and the second history information A2 outputted by the first core unit 101 are written into the first history RAM 141 and the second history RAM 142.

Further, when both the occupancy mode information DA4 outputted by the first core unit 101 and the occupancy mode information DB4 outputted by the second core unit 102 indicate invalidity, the first history information A1 outputted by the first core unit 101 is written into the first history RAM 141 and the first history information B1 outputted by the second core unit 102 is written into the second history RAM 142.

Further, when the occupancy mode information DA4 outputted by the first core unit 101 indicates validity and the occupancy mode information DB4 outputted by the second core unit 102 indicates invalidity, the first history information A1 and the second history information A2 outputted by the first core unit 101 are written into the first history RAM 141 and the second history RAM 142.

Further, when the occupancy mode information DA4 outputted by the first core unit 101 indicates invalidity and the occupancy mode information DB4 outputted by the second core unit 102 indicates validity, the first history information B1 and the second history information B2 outputted by the second core unit 102 are written into the first history RAM 141 and the second history RAM 142.

Further, when the occupancy mode information DA4 outputted by the first core unit 101 indicates validity and the sharing mode information PCMD outputted by the first core unit 101 is of invalidity, the first history information A1 outputted by the first core unit 101 is written into the first history RAM 141 and the second history information A2 outputted by the first core unit 101 is written into the second history RAM 142.

Further, when the occupancy mode information DA4 outputted by the first core unit 101 indicates validity and the sharing mode information PCMD outputted by the first core unit 101 is of validity, with both the first history RAM 141 and the second history RAM 142 being one address space, the first history information A1 and the second history information A2 outputted by the first core unit 101 are written into the first history RAM 141 and the second history RAM 142.

Further, when the occupancy mode information DB4 outputted by the second core unit 102 indicates validity and the sharing mode information PCMD outputted by the second core unit 102 is of invalidity, the first history information B1 outputted by the second core unit 102 is written into the first history RAM 141 and the second history information B2 outputted by the second core unit 102 is written into the second history RAM 142.

Further, when the occupancy mode information DB4 outputted by the second core unit 102 indicates validity and the sharing mode information PCMD outputted by the second core unit 102 is of validity, with both the first history RAM 141 and the second history RAM 142 being one address space, the first history information B1 and the second history information B2 outputted by the second core unit 102 are written into the first history RAM 141 and the second history RAM 142.

As described above, when the occupancy mode information DA4 of the first core unit 101 is of invalidity and the occupancy mode information DB4 of the second core unit 102 is of invalidity, the first history information A1 of the first core unit 101 is written into the first history RAM 141 with a comparatively small capacity, and the first history information B1 of the second core unit 102 is written into the second history RAM 142 with a comparatively small capacity.

In contrast, by validating the occupancy mode information DA4 of the first core unit 101, the first history information A1 and the second history information A2 of the first core unit 101 are written into the first history RAM 141 and the second history RAM 142 with a comparatively large capacity. Thereby, it becomes possible to perform a program analysis and an error analysis of the first core unit 101 in detail.

Similarly, by validating the occupancy mode information DB4 of the second core unit 102, the first history information B1 and the second history information B2 of the second core unit 102 are written into the first history RAM 141 and the second history RAM 142 with the comparatively large capacity. Thereby, it becomes possible to perform a program analysis and an error analysis of the second core unit 102 in detail.

Since a region to be used of the history RAM can be altered by occupancy mode information, it is not necessary to make a history RAM have a large capacity.

Further, a data bus of the first history information C1 is connected to the first history RAM 141 and a data bus of the second history information C2 is connected to the second history RAM 142. When one core unit 101 or 102 occupies the first history RAM 141 and the second history RAM 142, it becomes possible for the one core unit 101 or 102 to use the data bus of the first history information C1 of the first history RAM 141 and the data bus of the second history information C2 of the second history RAM 142, and thus the history information can be stored in the history RAMs 141 and 142 without wiring a superfluous data bus from the core units 101, 102 to the history unit 140.

It is possible to narrow a region into which history information is written when occupancy mode information indicates invalidity and to broaden a region into which history information is written when the occupancy mode information indicates validity.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processor, comprising:
a first core unit which outputs history information and occupancy mode information related to an arithmetic processing;
a memory which has a first storage area and a second storage area;
a control circuit which writes the history information outputted by the first core unit into the first storage area of the memory when the occupancy mode information outputted by the first core unit indicates invalidity, and writes the history information outputted by the first core unit into the first storage area and the second storage area of the memory when the occupancy mode information outputted by the first core unit indicates validity.

2. The processor according to claim 1, further comprising
a second core unit which outputs history information and occupancy mode information related to an arithmetic processing,
wherein the control circuit writes the history information outputted by the first core unit into the first storage area of the memory and writes the history information outputted by the second core unit into the second storage area of the memory, when both the occupancy mode information outputted by the first core unit and the occupancy mode information outputted by the second core unit indicate invalidity.

3. The processor according to claim 2,
wherein the control circuit
writes the history information outputted by the first core unit into the first storage area and the second storage area of the memory, when the occupancy mode information outputted by the first core unit indicates validity and the occupancy mode information outputted by the second core unit indicates invalidity, and
writes the history information outputted by the second core unit into the first storage area and the second storage area of the memory, when the occupancy mode information outputted by the first core unit indicates invalidity and the occupancy mode information outputted by the second core unit indicates validity.

4. The processor according to claim 1,
wherein in the control circuit
the first core unit outputs sharing mode information and outputs the history information including first history information and second history information,
wherein the control circuit
writes the first history information outputted by the first core unit into the first storage area of the memory and writes the second history information outputted by the first core unit into the second storage area of the memory, when the occupancy mode information outputted by the first core unit indicates validity and the sharing mode information outputted by the first core unit is of invalidity, and
writes the first history information and the second history information outputted by the first core unit into the first storage area and the second storage area of the memory, with both the first storage area and the second storage area of the memory being one address space, when the occupancy mode information outputted by the first core unit indicates validity and the sharing mode information outputted by the first core unit is of validity.

5. A control method of a processor which has a first core unit that outputs history information and occupancy mode information related to an arithmetic processing and a memory that has a first storage area and a second storage area, the method comprising:
writing the history information outputted by the first core unit into the first storage area of the memory when the occupancy mode information outputted by the first core unit indicates invalidity; and
writing the history information outputted by the first core unit into the first storage area and the second storage area of the memory when the occupancy mode information outputted by the first core unit indicates validity.
